(19) United States
(12) Patent Application Publication
(10) Pub. No.: US 2015/0365890 A1
(43) Pub. Date: Dec. 17, 2015

(54) System And Method For Reducing Power Consumption By A Network Node

(71) Applicant: Telefonaktiebolaget L M Ericsson (publ), Stockholm (SE)

(72) Inventors: Karupaiah Rajendran, Bangalore (IN); Eeswara Chandra Srikanth Pulugurta, Bengaluru (IN); Debasish Sarkar, Irvine, CA (US)

(21) Appl. No.: 14/305,711

(22) Filed: Jun. 16, 2014

(51) Int. Cl. H04W 52/02

(52) U.S. Cl. CPC H04W 52/0206

(57) ABSTRACT

According to some embodiments, a method for reducing power consumption in a network node includes determining that an operating bandwidth for a first cell is greater than a first predefined threshold and that a number of user devices being actively serviced by the network node are equal to or less than a second predefined threshold. At least one configuration change is performed to reduce power consumption by the network node.

### TECHNICAL FIELD

Particular embodiments relate generally to wireless communications and more particularly to a system and method for reducing power consumption by a network node in a Long Term Evolutions (LTE) network.

### BACKGROUND

LTE radio network design & dimensioning must take into account various factors, such as the different types of traffic carried by LTE networks, subscriber density, over subscription ratio to meet the busy hour traffic requirements, radio coverage confidence, and other variables. For example, the LTE channel bandwidth may be selected based on the number of active data clients in need of support and the minimum achievable downlink and uplink throughput requirements for the desired market or region. Typically, the LTE channel bandwidth may be selected to be 20 MHz or less.

In reality, the cell sites in a given market will not be fully loaded all of the time. For example, cell sites may experience down time at some point during a 24 hour period. Typically, the load on most cell sites may fall below 25% during at least 25% of the day. In some cell sites, the load may fall to zero. This period of reduced load may include the approximately six hours in a day in which most humans in the market area are sleeping. During such periods of inactivity, a cell site requires less channel bandwidth to support traffic in the cell site. Thus, a cell site that typically operates at channel bandwidth of 20 MHz may require substantially less channel band during at least 25% of the time in a day.

Electrical power consumption accounts for approximately 30% of the operational expenses associated with a radio base station (RBS). Fifty percent of this power consumption may be attributed to the power amplifiers. However, the power consumption of an RBS operating at 20 MHz will always be higher than the power consumption of the same RBS operating at 5, 3, or 1.4 MHz. This is true because a power amplifier working on a larger channel bandwidth requires more energy than a power amplifier operating on a lower channel bandwidth.

Even under no load conditions (i.e., there is no traffic), the RBS requires power to transmit reference signal resource elements in order to provide a certain level of coverage and allow subscriber mobility. The number of reference signal resource elements which are transmitted by an RBS operating at a 20 MHz channel bandwidth is four times higher than the number of reference signal resource elements transmitted by an RBS operating at 5 MHz. Likewise, the number of reference signal resource elements which are transmitted by a RBS operating at a 20 MHz channel bandwidth is approximately 10 times higher than a RBS operating at a 1.4 MHz channel bandwidth.

Other factors may also influence power consumption in a RBS. For example, any increase in traffic will also increase the power consumption of the RBS. Additionally, the more service the RBS provides to the subscribers connected to it, the higher the required output power from the radio units associated with the RBS. Generally, increased services result in increased physical resource block (PRB) utilization. Still another factor may be the power consumption of site equipment. For example, an air conditioner at an indoor RBS site increases power consumption by 20 to 30%. Power consumption may increase as much as 60%, depending upon how much power is required to cool the specific type of RBS employed. For an instance, the entire RBS 6201 may be placed in an indoors environment, which often requires site level cooling, whereas only the 6601 Main Unit is placed in an indoors environment, since the RRUS-01 is placed outdoors.

It may be desirable to conserve the energy used by the components of the RBS, especially during times of low load. However, current energy saving mechanisms and techniques are not able to dynamically adapt to a leaner channel bandwidth while maintaining the same radio coverage with no compromise of live traffic capacity.

### SUMMARY

Particular embodiments of the present disclosure may provide solutions to reduce power consumption in a network node based on cell loading. Certain embodiments may include functionality for reducing power consumption by dynamically switching a network node from a multi input multi output configuration (MIMO) to a single input multi output (SIMO) or a single input single output (SISO) configuration, reducing or scaling operating channel bandwidth, reducing power amplifier output, and/or sharing power amplifiers between sectors within a network node under no load or reduced load conditions.

According to some embodiments, a network node for providing service to cell sites includes one or more processors and a non-transitory computer-readable storage medium. The storage medium further includes computer-readable instructions that, when executed, cause the processor to determine that an operating bandwidth for a first cell is greater than a first predefined threshold and a number of user devices being actively serviced by the network node is equal to or less than a second predefined threshold. At least one configuration change is performed to reduce power consumption by the network node.

According to some embodiments, a method for reducing power consumption in a network node includes determining that an operating bandwidth for a first cell is greater than a first predefined threshold and a number of user devices being actively serviced by the network node is equal to or less than a second predefined threshold. At least one configuration change is performed to reduce power consumption by the network node.

According to some embodiments a non-transitory computer-readable storage medium has a computer program stored thereon. When executed on one or more processors, the computer program causes the one or more processors to determine that an operating bandwidth for a first cell is greater than a first predefined threshold and that a number of user devices being actively serviced by the network node is equal to or less than a second predefined threshold. At least one configuration change is performed to reduce power consumption by the network node.

According to some embodiments, a network node for providing service to a plurality of cells includes a transceiver comprising a plurality of amplifiers, one or more processors, and a non-transitory computer-readable storage medium. The storage medium includes computer-readable instructions that, when executed by the one or more processors, cause the processors to determine that an operating bandwidth for a first cell is greater than a first predefined threshold, determine that a physical resource block utilization is greater than a second predefined threshold, and determine whether the network node is operating in a multi input multi output configuration. If the network node is not operating in a multi input multi output configuration, the operating bandwidth is scaled down to a lowest possible operating bandwidth that can accommodate a current level of traffic. If the network node is operating in a multi input multi output configuration, the operating bandwidth is scaled to a lowest possible operating bandwidth that is supported by the network node. The network node is then dynamically switched from a multi input multi output (MIMO) configuration to a single input single output (SISO) configuration. A determination is made that all cells within the plurality of cells are operating at the lowest possible operating bandwidth supported by the network node and at least one power amplifier is deactivated.

Some embodiments of the disclosure may provide one or more technical advantages. For example, certain embodiments may reduce energy consumption based on cell loading. Specifically, the Self Organizing Network (SON) Energy Saving function may be optimized by enabling scaling of channel bandwidth of individual Radio Base Station (RBS) cell site based on instantaneous load. For example, certain embodiments may dynamically adapt to reduce the channel bandwidth to a leaner, or in some instances a leanest, channel bandwidth possible to maintain the same radio coverage with reduced power consumption without compromising live traffic capacity. Thus, only as much channel bandwidth may be used as is required. Thus, in certain embodiments, a technical advantage may be that power amplifiers may be scaled to a leaner channel bandwidth, thus preventing waste. As a result, a technical advantage may be that energy is conserved. However, certain embodiments may scale the channel bandwidth to a leaner setting while still maintaining the same radio coverage and without compromising live traffic capacity. It is possible to maintain the same radio coverage if the energy per resource element of the reference signals is maintained irrespective of the channel bandwidth.

Still another technical advantage may be the incorporation of dynamic tuning of multi input multi output (MIMO) configuration and settings. For example, certain embodiments may allow dynamic switching from a MIMO configuration to a single input single output (SISO) configuration or single input multiple output (SIMO) configuration. An additional advantage may be that such dynamic switching may be based on user load and/or the current operating QoS Class Index of the serviced subscribers.

Still another technical advantage may be that operating expenses and carbon footprints are reduced. For example, lower power modes may reduce electric grid consumption, mitigate the demand for costly diesel generation in remote locations, and reduce carbon footprints.

Some embodiments may benefit from some, none, or all of these advantages. Other technical advantages may be readily ascertained by one of ordinary skill in the art.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example of a network in which power consumption may be reduced according to certain embodiments;

FIG. 2 is a block diagram illustrating an example network node for reducing power consumption in a network;

FIG. 3 is a flow chart illustrating an example embodiment of a method for reducing power consumption in a network node by scaling operating bandwidth to a lowest supported setting;

FIG. 4 is a flow chart illustrating an example embodiment of a method for reducing power consumption in a network node by dynamically switching a network node from a multi input multi output (MIMO) configuration to a single input multi output (SIMO) or single input single output (SISO) configuration;

FIG. 5 is a flow chart illustrating an example embodiment of a method for reducing power consumption in a network node by deactivating at least one power amplifier;

FIG. 6 is a block diagram illustrating an example array of power amplifiers that may be optimized for power sharing;

FIG. 7 is a flow chart illustrating an example embodiment of a method for reducing power consumption by scaling operating bandwidth to a lowest possible bandwidth based on cell load;

FIG. 8 is a flow chart illustrating an example embodiment of a combination method for reducing power consumption by reducing operating bandwidth, dynamically switching the configuration of a network node, and/or deactivating at least one power amplifier;

FIG. 9 is a block diagram illustrating embodiments of a wireless device; and

FIG. 10 is a block diagram illustrating embodiments of a core network node.

### DETAILED DESCRIPTION

Particular embodiments of the present disclosure may provide solutions to reduce power consumption in a network node based on cell loading. Certain embodiments may include functionality for dynamically switching a network node from a multi input multi output configuration (MIMO) to a single input multi output (SIMO) or a single input single output (SISO) configuration, reducing operating bandwidth, reducing power amplifier output, and/or sharing power amplifiers between sectors within a network node under no load or reduced load conditions.

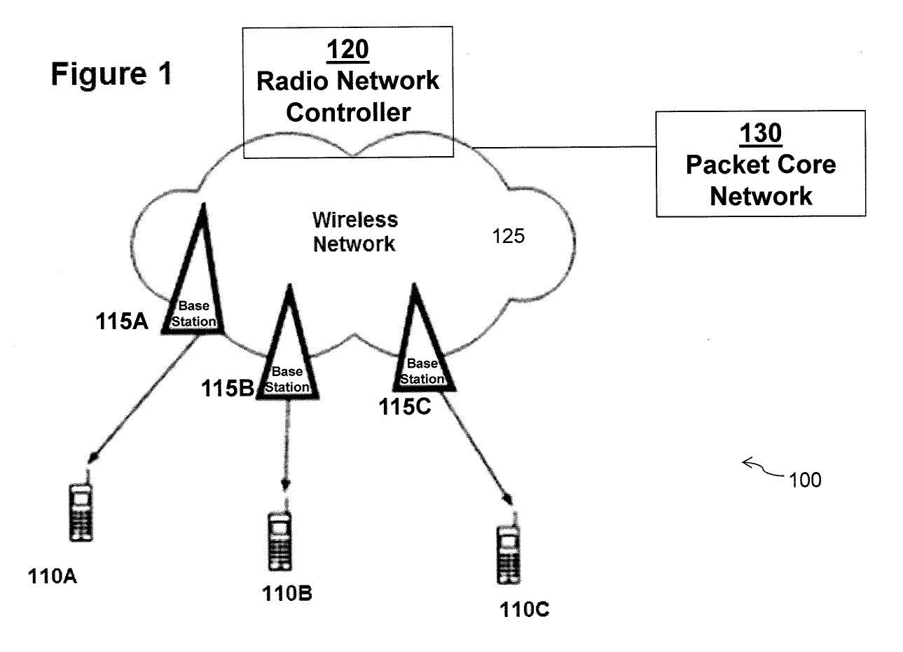

Particular embodiments are described in FIGS. 1-10 of the drawings, like numerals being used for like and corresponding parts of the various drawings. FIG. 1 is a block diagram illustrating an example of a network 100 in which power consumption may be optimized according to certain embodiments. Network 100 includes one or more wireless communication devices 110, a plurality of network nodes 115, radio network controller 120, and a packet core network 130. In the example, wireless communication device 110a communicates with network node 115a over a wireless interface. For example, wireless communication device 110a transmits wireless signals to network node 115a and/or receives wireless signals from network node 115a. The wireless signals contain voice traffic, data traffic, control signals, and/or any other suitable information.

As described with respect to FIG. 1 above, embodiments of network 100 may include one or more wireless communication devices 110, and one or more different types of network nodes capable of communicating (directly or indirectly) with wireless communication devices 110. Examples of the network nodes include network nodes 115, radio network controller 120, and core network nodes 130. The network may also include any additional elements suitable to support communication between wireless communication devices 110 or between a wireless communication device 110 and another communication device (such as a landline telephone).

A network node 115 refers to any suitable node of a radio access network/base station system. Examples include a radio access node (such as a base station or eNodeB) and a radio access controller (such as a base station controller or other node in the radio network that manages radio access nodes). Network node 115 interfaces (directly or indirectly) with core network node 130. For example, network node 115 interfaces with core network node 130 via an interconnecting network 125. Interconnecting network 125 refers to any interconnecting system capable of transmitting audio, video, signals, data, messages, or any combination of the preceding. Interconnecting network 125 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Core network node 130 manages the establishment of communication sessions and various other functionality for wireless communication device 110. Wireless communication device 110 exchanges certain signals with core network node 130 using the non-access stratum layer. In non-access stratum (NAS) signaling, signals between wireless communication device 110 and core network node 130 pass transparently through network nodes 120.

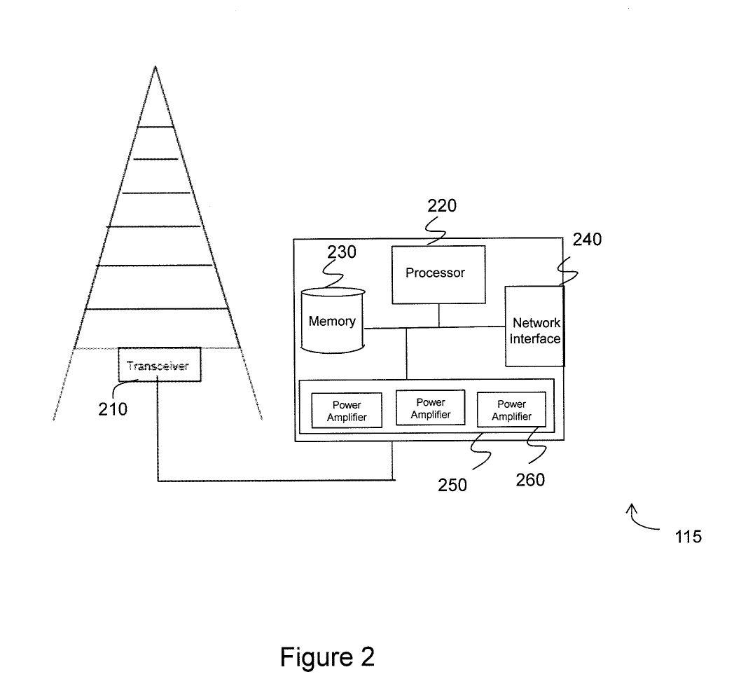

In certain embodiments, wireless communication device 110, network node 120, and core network node 130 use any suitable radio access technology, such as long term evolution (LTE), LTE-Advanced, UMTS, HSPA, GSM, cdma2000, WiMax, WiFi, another suitable radio access technology, or any suitable combination of one or more radio access technologies. For purposes of example, various embodiments may be described within the context of certain radio access technologies. However, the scope of the disclosure is not limited to the examples and other embodiments could use different radio access technologies. Each of wireless communication device 110, network node 115, radio network controller 120, and core network node 130 include any suitable combination of hardware and/or software. Examples of particular embodiments of a network node 115, wireless communication device 110, and core network node 130 are described with respect to FIGS. 2, 9, and 10, respectively.

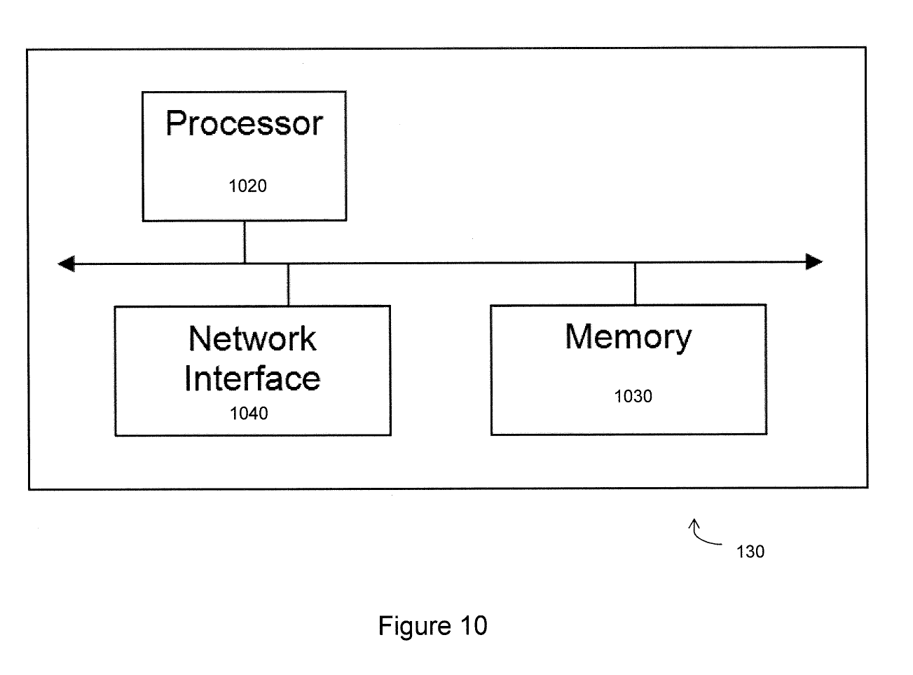

FIG. 2 is a block diagram illustrating embodiments of network node 115. In the illustration, network node 115 is shown as a radio access node, such as an eNodeB, a node B, a base station, a wireless access point (e.g., a Wi-Fi access point), a low power node, a base transceiver station (BTS), transmission points, transmission nodes, remote RF unit (RRU), remote radio head (RRH), etc. Other network nodes 115, such as one or more radio network controllers, may be configured between the radio access nodes and core network nodes 130. These other network nodes 115 may include processors, memory, and interfaces similar to those described with respect to FIG. 10, however, these other network nodes might not necessarily include a wireless interface, such as transceiver 210.

Radio access nodes are deployed throughout network 100 as a homogenous deployment, heterogeneous deployment, or mixed deployment. A homogeneous deployment generally describes a deployment made up of the same (or similar) type of radio access nodes and/or similar coverage and cell sizes and inter-site distances. A heterogeneous deployment generally describes deployments using a variety of types of radio access nodes having different cell sizes, transmit powers, capacities, and inter-site distances. For example, a heterogeneous deployment may include a plurality of low-power nodes placed throughout a macro-cell layout. Mixed deployments include a mix of homogenous portions and heterogeneous portions.

Network node 115 includes one or more of transceiver 210, processor 220, memory 230, network interface 240, and power amplifier array 250. Transceiver 210 may include one or more antennas that facilitate transmitting wireless signals to and receiving wireless signals from wireless communication device 110 (e.g., via an antenna). As will be described in more detail below, transceiver 210 may include antennas selectively configured as a multi input multi output (MIMO), single input multi output (SIMO), or single input single output (SISO) configuration. Power for transmitting and receiving signals via the one or more antennas may be provided by power amplifier array 250, which may include one or more power amplifiers 260. Network interface 240 communicates signals to backend network components, such as a gateway, switch, router, Internet, Public Switched Telephone Network (PSTN), other network nodes 115, radio network controllers 120, core network nodes 130, etc.

Processor 220 includes any suitable combination of hardware and software implemented in one or more modules to execute instructions and manipulate data to perform some or all of the described functions of network node 115, memory 230 stores the instructions executed by processor 220. In some embodiments, processor 220 includes, for example, one or more computers, one or more central processing units (CPUs), one or more microprocessors, one or more applications, and/or other logic.

Memory 230 is generally operable to store instructions, such as a computer program, software, an application including one or more of logic, rules, algorithms, code, tables, etc. and/or other instructions capable of being executed by a processor. Examples of memory 530 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 240 is communicatively coupled to processor 220 and refers to any suitable device operable to receive input for network node 115, send output from network node 115, perform suitable processing of the input or output or both, communicate to other devices, or any combination of the preceding. Network interface 240 includes appropriate hardware (e.g., port, modem, network interface card, etc.) and software, including protocol conversion and data processing capabilities, to communicate through a network.

Other embodiments of network node 115 may include additional components (beyond those shown in FIG. 2) responsible for providing certain aspects of the network node's functionality, including any of the functionality described above and/or any additional functionality (including any functionality necessary to support the solution described above). The various different types of radio access nodes may include components having the same physical hardware but configured (e.g., via programming) to support different radio access technologies, or may represent partly or entirely different physical components.

Generally, a network node 115 is located at a site and provides basic radio coverage for the site. However, the amount of power consumed by the network node 115 may be dependent upon a number of factors such as the network node type. For example, a general network node may be used for wide area coverage, whereas a micro or pico base station may provide spot coverage. A general network node may require more operating power than a micro or pico network node. Other factors that may affect the amount of power required include the number of active users in a cell site, the operating channel bandwidth, and/or the antenna configuration.

Table 1 illustrates the power consumption required for differing types of network nodes having varying configurations.

TABLE 1

| | | Energy Saving by | Energy Saving | |
|---|---|---|---|---|
| | | Bandwidth | by Bandwidth | Percentage Power |
| | RRU Output | Scaling from | Scaling from | Savings due to NO |
| | Power in Watts, | 20 MHz to 5 MHz | 20 MHz to 5 MHz | Load, Low Load |
| | per frequency | RRU Output | RRU Output | Period |
| | band per Sector | Power in Watts, | Power in Watts, | [25% of the time] |
| | (2T × 2R) | per frequency | per frequency | [6 hrs/day-Human |
| Network Node | [Channel BW = | band per Sector | band per Sector | Relaxation/Sleeping |
| Type | 20 MHz] | (2T × 2R) | (1T × 1R) | Period |
| General | 20 Watts (10 | 6.66 Watts (3.33 | 3.33 Watts | [83.35% (16.67 W/20 W) * |
| (Macro or Main- | Watts per | per Antenna Port) | | 0.25 |
| Remote or AIR) | Antenna Port) | | | (6 hr/24 hr) = |
| | | | | >20.83% Energy |
| | | | | Savings per day |
| | | | | per Sector |
| Micro | 5 Watts | 1.66 Watts | 0.83 Watts | 20.8% Energy |
| | | | | Savings per day |
| | | | | per Sector |
| Pico | 2 Watts | 0.66 Watts | 0.33 Watts | 20.8% Energy |
| | | | | Savings per day |
| | | | | per Sector |

As can be seen from the table, a general network node having two transmitters and two receivers may require approximately 20 Watts of power when operating in a 20 MHz channel bandwidth. However, the same cell site may consume only 6.66 Watts of power when the operating channel bandwidth is 5 MHz. Thus, an energy savings of approximately 13.34 Watts may be obtained by scaling the operating channel bandwidth to the lower setting. The energy may be further reduced by almost 50% when the network node is scaled to 5 MHz operating bandwidth and the antenna configuration is reduced to one transmitter and one receiver. During a no load or sleeping period, the energy savings may be more than 20% per day per sector.

As such, network 100 may use complex algorithms to allocate sufficient, but not excessive, output power to each user traffic channel and common channel while providing requested services. As described herein, certain embodiments may include functionality for reducing power consumption by dynamically switching a network node from a multi input multi output configuration (MIMO) to a single input multi output (SIMO) or a single input single output (SISO) configuration, reducing or scaling operating channel bandwidth, reducing power amplifier output, and/or sharing power amplifiers between sectors within a network node 115 under no load or reduced load conditions. As a result, operating expenses associated with network node 115 may be reduced.

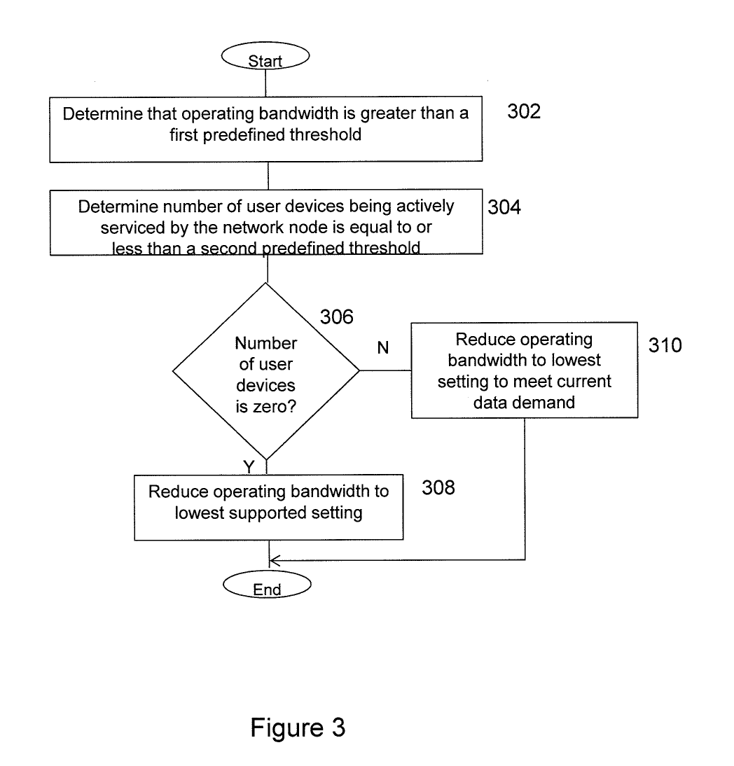

FIG. 3 is a flow chart illustrating an example embodiment of a method for reducing power consumption in a network node by reducing operating bandwidth to a lowest supported setting. The method begins at step 302 where it is determined that the operating bandwidth in a cell site is greater than a predefined threshold. For example, in certain embodiments, a network node 115 may be capable of operating at 20, 10, and 5 MHz. Thus, 5 MHz may be the lowest at which the network node 115 is capable of operating. Accordingly, in certain embodiments, it may be determined at step 302 that network node 115 is operating at a channel operating bandwidth that is greater than the lowest supported setting.

At step 304, the number of user devices 110 being serviced by the network node may be determined to be equal to or less than a second predefined threshold. Additionally, some embodiments may further require that the number of user devices 110 has been equal to or less than the predefined threshold for at least a predetermined interval of time. For example, the determination may be that the number of user devices 110 has been equal to or less than the predefined threshold for at least fifteen minutes, in a particular embodiment. Conditions such as these may indicate that the network node is experiencing low or zero traffic.

In a particular embodiment, processor 220 may include a counter for determining the number of user devices being actively serviced in both the downlink and uplink directions. Specifically, a counter may aggregate for each transmission time interval (TTI) the number of user devices in the downlink direction with data resource block (DRB) data to send. Likewise, a counter may aggregate for each TTI the number of user devices with buffer status reports indicating DRB data to be sent in the uplink direction. Processor 220 may then sum the number of user devices considered active in the downlink direction (pmActiveUeDlSum) and the number of user devices considered active in the uplink direction (pmActiveUeUISum) and compare it to the second predefined threshold at step 304. After a measurement period has passed, the counter may be reset. For example, in certain embodiments, the counter may be reset after every fifteen minutes.

At step 306, it may be determined whether the number of user devices is equal to zero, indicating a no load condition. Where the cell site is in a no load condition (such as might be the case during the hours when most users in the cell site would be sleeping), the operating channel bandwidth may be reduced to the lowest supported setting at step 308. For example, if the network node 115 is capable of operating at a lowest possible channel bandwidth of 5 MHz, then the operating channel bandwidth may be reduced to 5 MHz. However, if the network node 115 is capable of operating at a lowest possible channel bandwidth of 1.4 MHz, then the operating channel bandwidth may be reduced to 1.4 MHz.

Returning to step 306, if it is determined that the number of active user devices 110 is not zero, the operating channel bandwidth may be reduced to the lowest setting available to meet current data demand at step 310. Thus, if the network node 115 was previously operating at 20 MHz but may operate at 10 MHz and still be capable of meeting current traffic demand, then the operating channel bandwidth may be reduced to 10 MHz. Conversely, if the network node 115 is capable of meeting current wireless device traffic at 5 MHz, then the operating channel bandwidth may be reduced to 5 MHz. An operating channel of less than 5 MHz may be selected where the network node 115 is capable of operating at such levels.

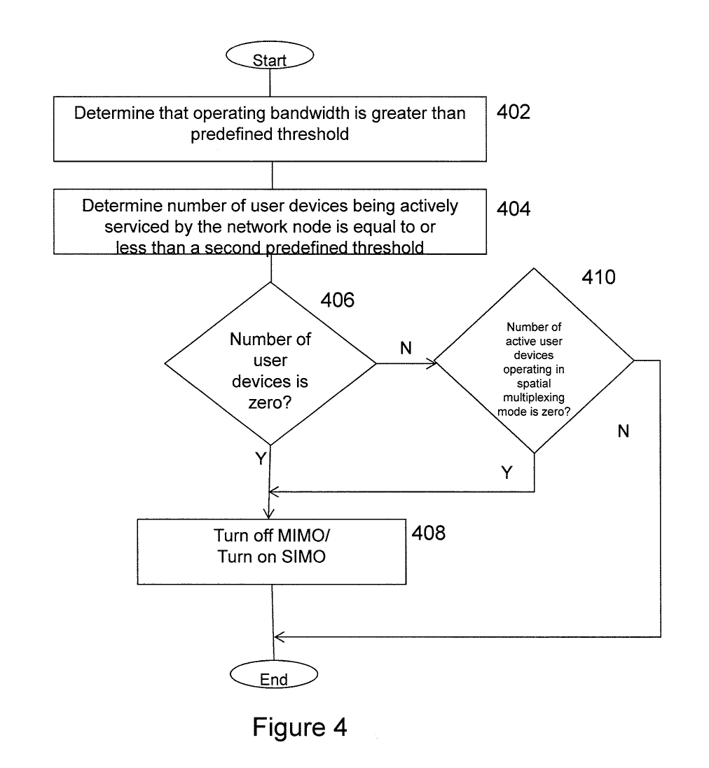

As discussed above, another method for additionally or alternatively reducing power consumption may be the dynamically switching of a network node 115 from a MIMO configuration to a SIMO or SISO configuration. FIG. 4 is a flow chart illustrating an example embodiment of a method for reducing power consumption in network node 115 by dynamically switching network node 115 from a MIMO configuration to a SIMO or SISO configuration. The method is similar to that described above with regard to FIG. 3 and begins with the determination that the operating bandwidth in a cell site is greater than a predefined threshold at step 402. Similar to step 302 of FIG. 3, certain embodiments may operate to determine whether the current operating channel bandwidth is greater than 5 MHz.

At step 404, the number of user devices 110 being serviced by the network node may be determined to be equal to or less than a second predefined threshold. Additionally, some embodiments may further require that the number of user devices 110 has been equal to or less than the predefined threshold for at least a predetermined interval of time. For example, the determination may be that the number of user devices 110 has been equal to or less than the predefined threshold for at least fifteen minutes, in a particular embodiment.

At step 406, it may be determined whether the number of user devices is equal to zero, indicating a no load condition. Where the cell site is in a no load condition (such as might be the case during the hours when most users in the cell site would be sleeping), the network node 115 may be switched from a MIMO configuration to a SIMO or SISO configuration at step 408. For example, a cell site operating with a configuration of two transmitters and two receivers may switch to a configuration that uses one transmitter and one receiver.

Returning to step 306, if it is determined that the number of active user devices 110 is not zero, a further determination as to whether the number of active user devices operating in spatial multiplexing mode is zero is made at step 410. If there are active user devices operating in spatial multiplexing mode, the method ends. However, if there are no active user devices 110 operating in spatial multiplexing mode then the network node 115 may be switched from a MIMO configuration to a SIMO or SISO configuration at step 408.

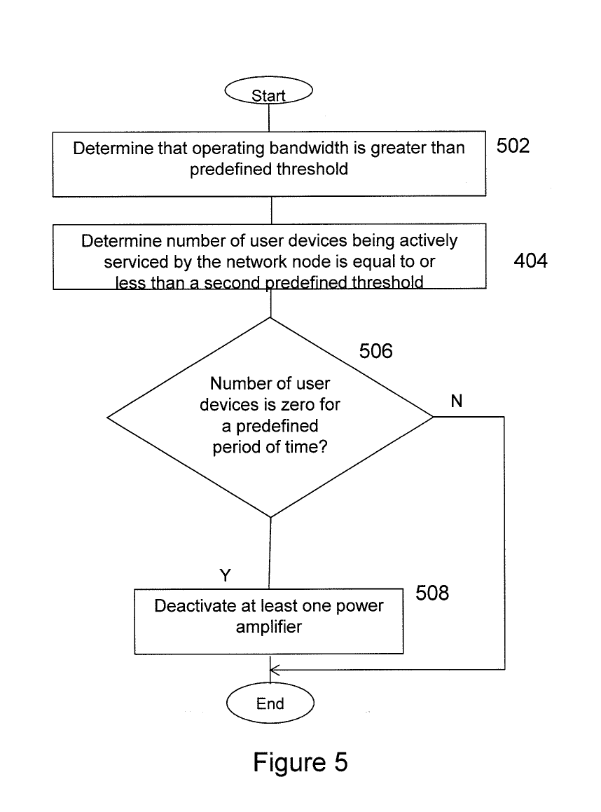

As discussed above, another method for additionally or alternatively reducing power consumption may be the sharing of node resources. FIG. 5 is a flow chart illustrating an example embodiment of a method for reducing power consumption in network node 115 by activating power sharing to result in at least one deactivated power amplifier 260. The method is similar to that described above with regard to FIGS. 3 and 4 and begins with the determination that the operating bandwidth in a cell site is greater than a predefined threshold at step 502. Similar to step 302 of FIG. 3, certain embodiments may operate to determine whether the current operating channel bandwidth is greater than 5 MHz.

At step 504, it is determined that the number of user devices 110 being serviced by the network node is equal to or less than a second predefined threshold. As discussed above, processor 220 may include a counter for determining the number of user devices being actively serviced in both the downlink and uplink directions. Specifically, a counter may aggregate for each TTI the number of user devices in the downlink direction with DRB data to send. Likewise, a counter may aggregate for each TTI the number of user devices with buffer status reports indicating DRB data to be sent in the uplink direction. Processor 220 may then sum the number of user devices considered active in the downlink direction (pmActiveUeDlSum) and the number of user devices considered active in the uplink direction (pmActiveUeUISum) and compare it to the second predefined threshold at step 304. After a measurement period has passed, the counter may be reset. For example, the counter may be reset after every fifteen minutes.

At step 506, it may be determined whether the number of user devices 110 being actively serviced has been equal to zero for a predetermined amount of time. In a particular embodiment, the predetermined interval time may be approximately 30 minutes. Additionally, historical statistics from the Operation Sub System-Radio and Core (OSS-RC) may be used to determine that a zero load condition for the predetermined amount of time indicates that the cell site may be considered to be in a sleep condition (such as might coincide with the hours when most users in the cell site would be sleeping). Where it is determined that the cell site is not in a no load condition, the method may end. However, where it is determined that the cell site is in a no load condition, power amplifier sharing may be activated at step 508.

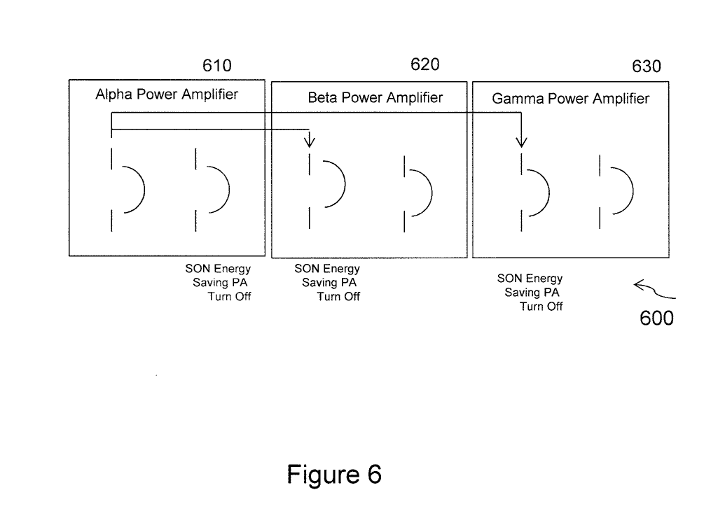

FIG. 6 is a block diagram illustrating an example array 600 of power amplifiers that may be optimized for power sharing. In the illustrated embodiment, array 600 includes an alpha power amplifier 610, a beta power amplifier 620, and a gamma power amplifier 630. As described above with respect to step 506 of FIG. 5, when the number of user devices is zero for a predetermined interval of time, power sharing may be activated. Specifically, one power amplifier 610, 620, or 630 may be used for all three cell sectors by tapping an antenna port of the activated power amplifier to the deactivated power amplifiers. As, shown in FIG. 6, the alpha power amplifier 610 remains activated while the beta and gamma power amplifiers 620 and 630 are deactivated. Though it is illustrated that only one power amplifier remains activated during a power sharing mode, it may be appreciated that multiple power amplifiers may remain activated where appropriate. Thus, power amplifiers 610 and 620 could remain active while only power amplifier 630 is deactivated. Likewise, power amplifiers 610 and 630 could remain active while only power amplifier 620 is deactivated. Thus, power sharing requires only that one power amplifier be deactivated and tapped to any operational power amplifier.

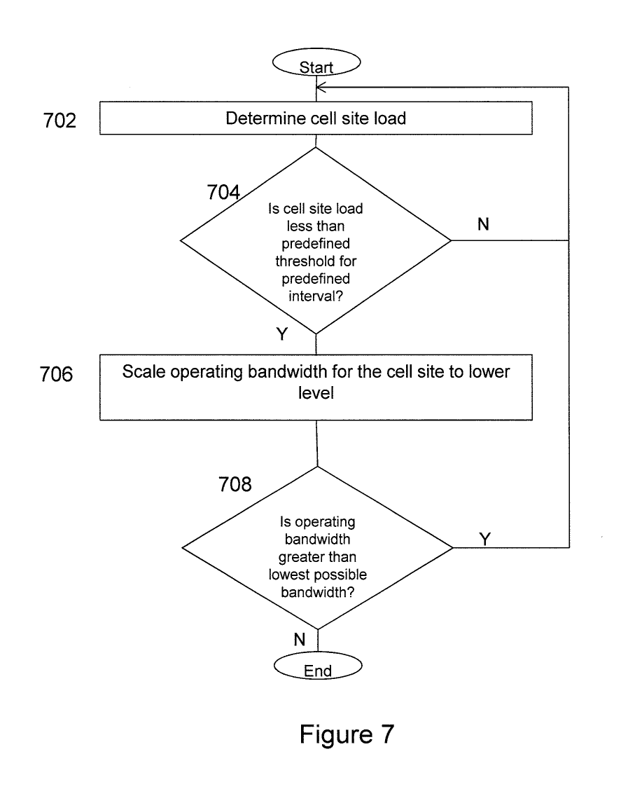

FIG. 7 is a flow chart illustrating an example embodiment of a method for additionally or alternatively reducing power consumption by iteratively scaling operating bandwidth to a lowest possible bandwidth based on cell load. The method begins at step 702 with the determination of cell site load. In a particular embodiment, the cell site load may include the sum of the total number of physical resource block (PRB) pairs used for data radio bearers in the downlink (pmPrbUsedDIDtch) and the total number of PRB pairs used for data radio bearers in the uplink (pmPrbUsedUIDtch). The pmPrbUsedDIDtch measurement may be applicable to the Dedicated Traffic Channel (DTCH) on the Physical Downlink Shared Channel (PDSCH). Conversely, the pmPrbUsedUIDtch measurement may be applicable to the DTCH on the Physical Uplink Shared Channel (PUSCH).

At step 704, it is determined whether the cell site load is less than a predefined threshold for a predefined interval. In a particular embodiment, for example, processor 220 may determine if the cell site load (pmPrbUsedDIDtch+pmPrbUsedUIDtch) is less than twenty-five percent of the available physical resource blocks for predefined interval of approximately fifteen minutes. However, it is generally recognized that the predefined threshold and predefined interval may vary as appropriate.

Where the cell site load is not less than the predefined threshold for the predefined interval, the method returns to step 702 and the cell site load may be again measured. Conversely, where the cell site load is less than the predefined threshold for the predefined interval, the operating bandwidth for the cell site may be scaled to a lower level at step 706. For example, if the operating bandwidth for the cell site was set at 20 MHz, the operating bandwidth may be reduced to 10 MHz. As another example, if the operating bandwidth for the cell site was set at 10 MHz, the operating channel bandwidth may be reduced to 5 MHz. Similarly, if the operating bandwidth for the cell site was set at 5 MHz, the operating channel bandwidth may be reduced to 3 MHz or 1.4 MHz.

At step 708, it is determined whether the operating bandwidth after scaling is greater than the lowest possible bandwidth. If the operating bandwidth is not greater than the lowest possible bandwidth, then the network node 115 is operating at the most efficient operating bandwidth supported by the network node 115 and the method ends. If, however, the operating bandwidth is greater than the lowest possible bandwidth, network node 115 is capable of operating more efficiently. In this scenario, the method returns to 702 to again determine current cell site load. The method may cycles through steps 702 to 708 such that the operating bandwidth of network node 115 is iteratively reduced until it is determined at step 708 that the network node 115 is operating at the lowest possible bandwidth supported by network node 115.

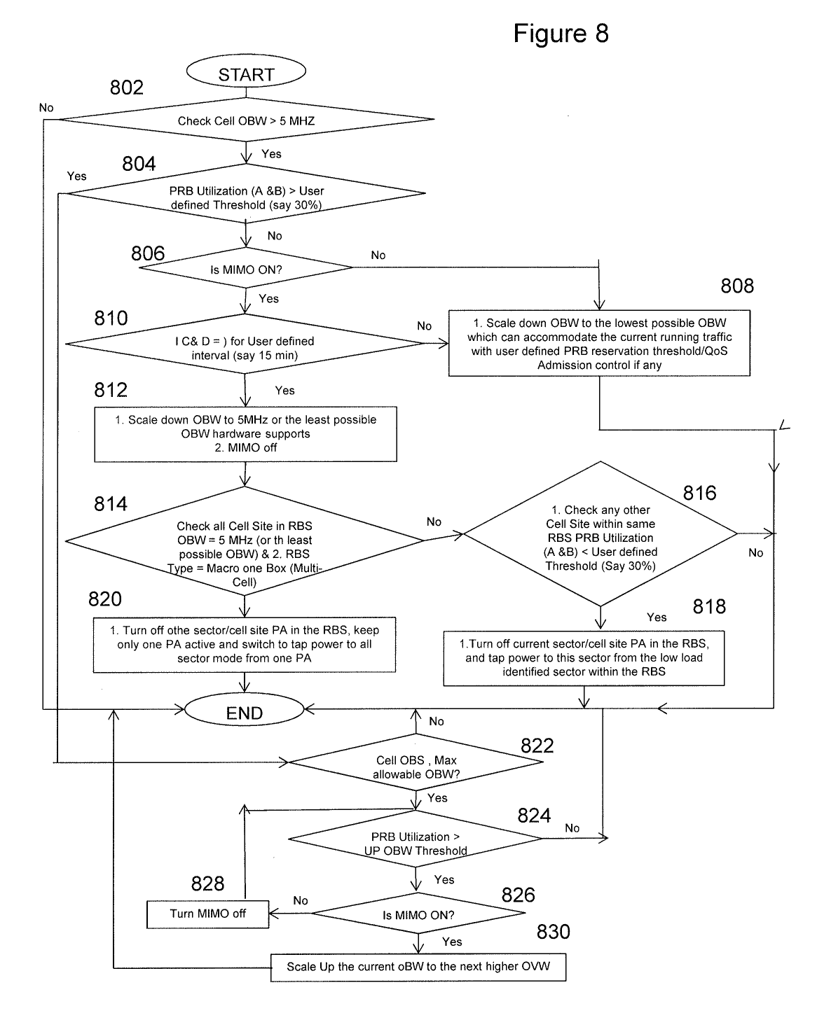

FIG. 8 is a flow chart illustrating an example embodiment of a method for reducing power consumption by using a combined approach that includes reducing operating bandwidth, dynamically switching the configuration of a network node, and/or deactivating at least one power amplifier to implement power sharing. The method begins at step 802 with a determination as to whether the cell operating bandwidth is greater than 5 MHz. In this example, 5 MHz is assumed to be the lowest possible operating bandwidth supported by the network node. However, it is possible that a lower operating bandwidth, such as 3 MHz, 1.4 MHz, or another operating bandwidth, may be supported. If it is determined that the cell operating bandwidth is not greater than the lowest possible operating bandwidth, the method terminates since the network node 115 is operating as efficiently as possible.

If the cell operating bandwidth is greater than the lowest possible operating bandwidth, a determination is made at step 804 as to whether PRB utilization is greater than a predefined threshold. In a particular embodiment, the PRB utilization may include the sum of pmPrbUsedDIDtch and pmPrbUsedUIDtch. As described above, the pmPrbUsedDIDtch measurement may be applicable to the DTCH on the PDSCH while the pmPrbUsedUIDtch measurement may be applicable to the DTCH on the PUSCH. If for example, the sum of pmPrbUsedDIDtch and pmPrbUsedUIDtch is greater than 30% the method may continue to step 806.

At step 806, a determination is made as to whether network node 115 is operating in a MIMO configuration. If the network node 115 is not operating in a MIMO configuration, the operating bandwidth may be scaled at step 808. Specifically, the operating bandwidth may be scaled to the lowest possible operating bandwidth that is capable of accommodating the current traffic load. In particular embodiments, any user defined PRB reservation requirements and Quality of Service (QoS) Admission control may be considered. The method may then terminate.

Conversely, if it is determined at step 806 that network node 115 is operating in a MIMO configuration, it is further determined at step 810 whether the number of user devices 110 being serviced by network node 115 has been equal to zero for a predetermined time interval. As discussed above, in particular embodiments, processor 220 may include a counter for determining the number of user devices being actively serviced in both the downlink and uplink directions. Specifically, a counter may aggregate for each TTI, the number of user devices in the downlink direction with DRB data to send. Likewise, the counter may aggregate for each TTI the number of user devices with buffer status reports indicating DRB data to be sent in the uplink direction. Processor 220 may then sum the number of user devices considered active in the downlink direction (pmActiveUeDlSum) and the number of user devices considered active in the uplink direction (pmActiveUeUISum) and determine if the sum is equal to zero. In particular embodiments, the predefined time interval may be approximately 15 minutes. Similarly, the counter may be reset every fifteen minutes.

If the active number of users has not been equal to zero for the predefined interval of time, the method returns to step 808 and the operating bandwidth is scaled to the lowest possible operating bandwidth capable of accommodating current traffic. However, if the active number of uses has been equal to zero for the predefined interval of time, the method proceeds to step 812 and the operating bandwidth is scaled to the lowest possible operating bandwidth that the hardware of network node 115 is capable of supporting. Additionally, the configuration of network node 115 may be switched from MIMO to SIMO OR SISO at step 812.

At step 814, it is determined if the following conditions are met: 1) network node 115 is a macro one box (multi-cell) network node and 2) the operating channel bandwidth for all cell sites of network node 115 is set to the least possible operating bandwidth supported by network node 115. If either condition is not met, the method continues to step 816 and all other cell sites within network node 115 may be checked to determine if the PRB utilization of such cell sites is less than a user defined threshold. If no cell sites have a PRB utilization less than the predefined threshold, the method terminates. If, however, a cell site is found to have a PRB utilization less than the predefined threshold, then the power amplifier for that cell site is deactivated at step 818. Power to this sector may be tapped from the low load identified sector within network node 115.

Returning to step 814, if it is determined that the two conditions described above are met, the method proceeds to step 820 with the deactivation of all but one of the power amplifiers. Power to all deactivated cell sites may be tapped from the power amplifier associated with the low load cell site. The method may then terminate.

Returning to step 804, if it is determined that PRB utilization is greater than the predefined threshold, the method may proceed to step 822 and a determination may be made as to whether the cell operating bandwidth is less than a maximum allowable operating bandwidth. If the operating bandwidth is not less than the maximum allowable operating bandwidth, the method terminates. However, if the operating bandwidth is less than the maximum allowable operating bandwidth, a determination may be made at step 824 as to whether PRB utilization is greater than an uplink operating bandwidth threshold. If the PRB utilization is not greater than the uplink operating bandwidth threshold, the method terminates. However, if the converse is true, a determination is made at step 826 as to whether network node 115 is operating with a MIMO configuration. If the network node is operating with a MIMO configuration, the configuration of network node 115 is switched to SIMO or SISO at step 828 and the method returns to step 824. If, however, network node 115 is not operating with a MIMO configuration, the current operating bandwidth may be scaled up to the next higher operating bandwidth. Thus, if network node is operating at a current operating bandwidth of 5 MHz, the operating bandwidth may be scaled up to 10 MHz. The method may then terminate.

Thus, in this manner the different approaches may be combined to result in further optimized power conservation and energy savings. An example calculation may be performed to demonstrate power savings achievable using the methods described above. Table 2 demonstrates the power per Resource Element (RE) required for network node 115 in a MIMO configuration versus the same network node 115 in a non-MIMO configuration (i.e., SISO or SIMO).

TABLE 2

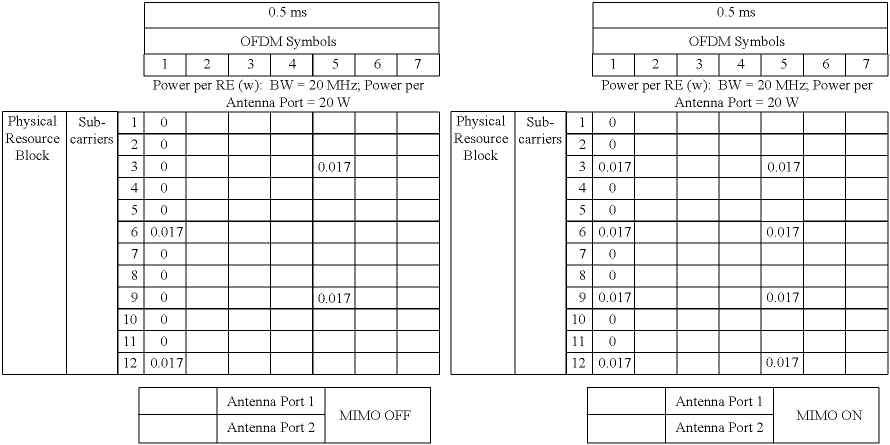

Assume that a cell site operating in 20 MHz channel bandwidth has 100 PRBs and is capable of operating in with either four transmitters and four receivers or two transmitters and two receivers transmitters. Each PRB contains four Reference Signal Resource Elements (RSRE) in 0.5 ms per antenna port. An energy can be performed for a cell site of a network node 115 with the following assumptions:
20 Watts transmission power per antenna port
20 MHz operating bandwidth
MIMO Configuration=ON, Config Type: 2T×2Rx
No Active/Connected Users
Excluding Control channel energy consumption computation

An LTE System operating in 20 MHz channel operating bandwidth contains 1200 subcarriers inclusive of pilot and data subcarriers excluding one DC/Null subcarrier and guard subcarriers on the left and right side of the channel bandwidth extremes. The power per subcarrier per resource element can be calculated as follows:

20 Watts/1200=0.01667

approximated to 0.0167 Watts per RE.

Thus, the power is calculated as approximately 0.0167 Watts per RE.

The Power requirement for RSRE in a 20 MHz system for one Antenna Port for every 0.5 ms time slot (D) can be calculated as follows:
A=No of PRBs in 20 MHz LTE system=100
B=No of RSRE in 0.5 ms time slot per PRB
C=Power per RSRE with 20 Watts Output Power per Antenna Port=0.0167 Watts
D=A*B*C=100*4*0.0167=6.68 Watts
   Thus, the power consumption per antenna port is approximately 6.68 Watts per 0.5 ms. The power consumption per hour (E) may then be calculated as follows:

$$\begin{matrix}E = D * 2 * 1000 * 3600 \\ = 6.68 Watts * 2 * 1000 * 3600 \\ = 13.33 kilowatt \text{-} hour or 47988 kJ ( Energy per hour )\end{matrix}$$

From this information, the RSRE Power requirement per hour (F) can be calculated as follows:

F=E*2=13.33*2=26.67 kilowatt-hour or 95976 kJ

The results of the above calculations can be found in line 1 of Table 3.

| | Instantaneous | | | | | | | |
|---|---|---|---|---|---|---|---|---|
| | Power Per | | | No of RSRE | | Energy | | |
| | Antenna Port | | | in 0.5 ms | No of | consumption | Energy | Energy |
| | with Full | | Power per | time slot | RSRE | of RSREs in | consumption | consumption |
| | Load in Watts | Channel | RSRE in Watts | per Antenna | in 1 | kilowatt-hour | of RSREs in | of RSREs in |
| | for 71.36 us | Bandwidth | (71.36 us | Port | sec in | (kW · h) | (kW · h) | (kW · h) |
| SNo | granularity | in MHz | granularity) | (1 Tx 1 Rx) | 1000 s | (1 Tx 1 Rx) | (2 Tx 2 Rx) | (4 Tx 4 Rx) |
| 1 | 20 | 20 | 0.016666667 | 400 | 800 | 13.33333333 | 26.66666667 | 53.33333333 |
| 2 | 15 | 15 | 0.016666667 | 300 | 600 | 10 | 20 | 40 |
| 3 | 10 | 10 | 0.016666667 | 200 | 400 | 6.666666667 | 13.33333333 | 26.66666667 |
| 4 | 5 | 5 | 0.016666667 | 100 | 200 | 3.333333333 | 6.666666667 | 13.33333333 |
| 5 | 3 | 3 | 0.016666667 | 60 | 120 | 2 | 4 | 8 |
| 6 | 1.2 | 1.4 | 0.016666667 | 24 | 48 | 0.8 | 1.6 | 3.2 |

Table 3 also summarizes similar calculations for cell sites operating at 15, 10, 5, 3, and 1.2 MHz.

Now consider an LTE System operating in 5 MHz channel bandwidth. Such system contains 300 subcarriers inclusive of pilot and data subcarriers excluding one DC/Null subcarrier and guard subcarriers on the left and right side of the channel bandwidth extremes. The power per subcarrier per resource element is equal to the power amplifier output power divided by the number of modulation/useful subcarriers.

A reverse calculation can be performed to arrive at the power amplifier output power of the 5 MHz LTE system where the RSRE power is kept constant at approximately 0.0167 Watts so that the system meets the same radio coverage requirement of the 20 MHz system considered above. The power amplifier output power (G) is calculated as follows:

$$\begin{matrix}G = 0.0167 Watts ( RSRE power ) * \\ Number of useful subcarriers in 1.4 MHz \\ = 0.0167 * 300 \\ = 500 Watts\end{matrix}$$

Thus, the required output power of the power amplifier is 5 Watts for a 5 MHz system. This is substantial energy savings over the same system operating at 20 MHz operating bandwidth which requires 20 Watts of power to meet the same radio coverage in no load condition. Where the system is also capable of operating in 1.4 MHz operating channel bandwidth, additional energy savings may be found.

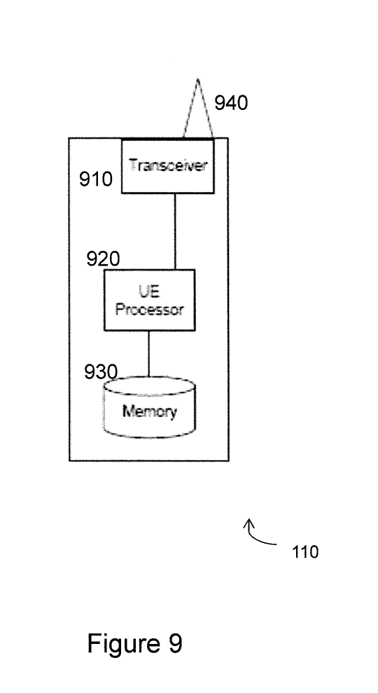

FIG. 9 is a block diagram illustrating an example of wireless communication device 110. Examples of wireless communication device 110 include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or another device that can provide wireless communication. A wireless communication device 110 may also be referred to as user equipment (UE), a station (STA), a mobile station (MS), a device, a wireless device, or a terminal in some embodiments. Wireless communication device 110 includes transceiver 910, processor 920, and memory 930. In some embodiments, transceiver 910 facilitates transmitting wireless signals to and receiving wireless signals from network node 120 (e.g., via an antenna 940), processor 920 executes instructions to provide some or all of the functionality described above as being provided by wireless communication device 110, and memory 930 stores the instructions executed by processor 920. In a particular embodiment, transceiver 910 includes a first transmitter for communicating with the user devices 110 within a cluster 204 at a first frequency and a second transmitter for communicating with the serving network node 115 at a second frequency.

Processor 920 includes any suitable combination of hardware and software implemented in one or more modules to execute instructions and manipulate data to perform some or all of the described functions of wireless communication device 110. In some embodiments, processor 920 includes, for example, one or more computers, one or more central processing units (CPUs), one or more microprocessors, one or more applications, and/or other logic.

Memory 930 is generally operable to store instructions, such as a computer program, software, an application including one or more of logic, rules, algorithms, code, tables, etc. and/or other instructions capable of being executed by a processor. Examples of memory 930 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless communication device 110 include additional components (beyond those shown in FIG. 9) responsible for providing certain aspects of the wireless communication device's functionality, including any of the functionality described above and/or any additional functionality (including any functionality necessary to support the solution described above).

FIG. 10 is a block diagram illustrating a core network node 130. Examples of core network node 130 can include a mobile switching center (MSC), a serving GPRS support node (SGSN), a mobility management entity (MME), a radio network controller (RNC), a base station controller (BSC), and so on. Core network node 130 includes processor 1020, memory 1030, and network interface 1040. In some embodiments, processor 1020 executes instructions to provide some or all of the functionality described above as being provided by core network node 130, memory 1030 stores the instructions executed by processor 120, and network interface 1040 communicates signals to an suitable node, such as a gateway, switch, router, Internet, Public Switched Telephone Network (PSTN), network nodes 120, other core network nodes 130, etc.

Processor 1020 includes any suitable combination of hardware and software implemented in one or more modules to execute instructions and manipulate data to perform some or all of the described functions of core network node 130. In some embodiments, processor 1020 includes, for example, one or more computers, one or more central processing units (CPUs), one or more microprocessors, one or more applications, and/or other logic.

Memory 1030 is generally operable to store instructions, such as a computer program, software, an application including one or more of logic, rules, algorithms, code, tables, etc. and/or other instructions capable of being executed by a processor. Examples of memory 1030 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1040 is communicatively coupled to processor 1020 and may refer to any suitable device operable to receive input for core network node 130, send output from core network node 130, perform suitable processing of the input or output or both, communicate to other devices, or any combination of the preceding. Network interface 1040 includes appropriate hardware (e.g., port, modem, network interface card, etc.) and software, including protocol conversion and data processing capabilities, to communicate through a network.

Other embodiments of core network node 130 include additional components (beyond those shown in FIG. 10) responsible for providing certain aspects of the core network node's functionality, including any of the functionality described above and/or any additional functionality (including any functionality necessary to support the solution described above).

Some embodiments of the disclosure may provide one or more technical advantages. For example, certain embodiments may reduce energy consumption based on cell loading. Specifically, the Self Organizing Network (SON) Energy Saving function may be optimized by enabling scaling of channel bandwidth of individual Radio Base Station (RBS) cell site based on instantaneous load. For example, certain embodiments may dynamically adapt to reduce the channel bandwidth to a leaner, or in some instances a leanest, channel bandwidth possible to maintain the same radio coverage with reduced power consumption without compromising live traffic capacity. Thus, only as much channel bandwidth may be used as is required. Thus, in certain embodiments, a technical advantage may be that power amplifiers may be scaled to a leaner channel bandwidth, thus preventing waste. As a result, a technical advantage may be that energy is conserved. However, certain embodiments may scale the channel bandwidth to a leaner setting while still maintaining the same radio coverage and without compromising live traffic capacity. It is possible to maintain the same radio coverage if the energy per resource element of the reference signals is maintained irrespective of the channel bandwidth.

Still another technical advantage may be the incorporation of dynamic tuning of multi input multi output (MIMO) configuration and settings. For example, certain embodiments may allow dynamic switching from a MIMO configuration to a single input single output (SISO) configuration or single input multiple output (SIMO) configuration. An additional advantage may be that such dynamic switching may be based on user load and/or the current operating QoS Class Index of the serviced subscribers.

Still another technical advantage may be that operating expenses and carbon footprints are reduced. For example, lower power modes may reduce electric grid consumption, mitigate the demand for costly diesel generation in remote locations, and reduce carbon footprints.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

Abbreviations used in the preceding description include:
UE: User Equipment
ANR: Automatic Neighbor relation
TA: Timing Advance
PCI: Physical Cell ID
OSS-RC: Operation Sub System-Radio and Core
RBS: Radio Base Station
RU: Radio Unit
RRU: Remote Radio Unit
BW: Bandwidth
MIMO: Multiple Input Multiple Output
SISO: Single Input Single Output
SIMO: Single Input Multiple Output
PRB: Physical Resource Block
SON: Self Organizing Network
CDD: Cyclic Delay Diversity

1. A network node for providing service to a plurality of cells, comprising:
one or more processors; and
a non-transitory computer-readable storage medium further including computer-readable instructions that, when executed by the one or more processors, are configured to:
determine that an operating bandwidth for a first cell is greater than a first predefined threshold;
determine that a number of user devices being actively serviced by the network node is equal to or less than a second predefined threshold; and
perform at least one configuration change to reduce power consumption by the network node.

2. The network node of claim 1, wherein the one or more processors are further configured to:
determine that the number of user devices being actively serviced by the network node has been less than or equal to the second predefined threshold for more than a predetermined amount of time.

3. The network node of claim 2, wherein when performing the at least one configuration change, the one or more processors are further configured to deactivate at least one power amplifier in the network node.

4. The network node of claim 1, wherein the number of user devices that are being actively serviced comprises the number of user devices active in a downlink direction and the number of user devices active in the uplink direction.

5. The network node of claim 1, wherein:
the second predefined threshold is zero; and
when performing the at least one configuration change, the one or more processors are configured to perform a step selected from the group consisting of:
reducing the operating bandwidth for the first cell to a lowest possible bandwidth supported by the network node;
switching the network node from a multi input multi output configuration to a single input multi output or single input single output configuration;
determining that no active user devices are operating in spatial multiplexing mode and switching the network node from a multi input multi output configuration to a single input multi output or single input single output configuration.

6. The network node of claim 1, wherein, when performing the at least one configuration change, the one or more processors are further configured to reduce the operating bandwidth for the first cell to a lowest possible bandwidth supported by the network node, the lowest possible bandwidth supported by the network node is selected from the group comprising 5 MHz, 3 MHz, and 1.4 MHz.

7. The network node of claim 1, wherein:
the second predefined threshold is associated with a low load setting; and
when performing the at least one configuration change, the one or more processors are further configured to reduce the operating bandwidth for the first cell to a lowest possible bandwidth that will support the number of user devices being actively supported by the network node.

8. The network node of claim 1, wherein the one or more processors are further configured to:
determine that the network node is operating at the lowest operating bandwidth supported by the network node; and
dynamically switch the network node from a MIMO configuration to a SISO configuration.

9. The network node of claim 1, wherein:
when determining that an operating bandwidth for a first cell is greater than a first predefined threshold, the one or more processors is further configured to determine that a cell site load is less than the first predefined threshold for a predefined interval; and
when performing the at least one configuration change, the one or more processors are configured to:
scale the operating bandwidth for the cell site to a next lower level;
determine whether the operating bandwidth after scaling is greater than a lowest possible bandwidth supported by the network node;
if the operating bandwidth after scaling is greater than the lowest possible bandwidth supported by the network node, scale the operating bandwidth a next lower level if the next lower level supports the cell site load.

10. A method for reducing power consumption in a network node, comprising:
determining that an operating bandwidth for a first cell is greater than a first predefined threshold;
determining that a number of user devices being actively serviced by the network node is equal to or less than a second predefined threshold; and
performing at least one configuration change to reduce power consumption by the network node.

11. The method of claim 10, further comprising determining that the number of user devices being actively serviced by the network node has been less than or equal to the second predefined threshold for more than a predetermined amount of time.

12. The method of claim 11, wherein performing the at least one configuration change comprises deactivating at least one power amplifier in the network node.

13. The method of claim 10, wherein the number of user devices that are being actively serviced comprises the number of user devices active in a downlink direction and the number of user devices active in the uplink direction.

14. The method of claim 10, wherein:
the second predefined threshold is zero; and
performing the at least one configuration change comprises performing a step selected from the group consisting of:
reducing the operating bandwidth for the first cell to a lowest possible bandwidth supported by the network node;
switching the network node from a multi input multi output configuration to a single input multi output or single input single output configuration; and
determining that no active user devices are operating in spatial multiplexing mode and switching the network node from a multi input multi output configuration to a single input multi output or single input single output configuration.

15. The method of claim 10, wherein performing the at least one configuration change comprises reducing the operating bandwidth for the first cell to a lowest possible bandwidth supported by the network node, the lowest possible bandwidth supported by the network node is selected from the group comprising 5 MHz, 3 MHz, and 1.4 MHz.

16. The method of claim 10, wherein:
the second predefined threshold is associated with a low load setting; and
performing the at least one configuration change comprises reducing the operating bandwidth for the first cell to a lowest possible bandwidth that will support the number of user devices being actively supported by the network node.

17. The method of claim 10, further comprising:
determining that the network node is operating at the lowest operating bandwidth supported by the network node; and
dynamically switching the network node from a MIMO configuration to a SISO configuration.

18. The method of claim 10, wherein:
determining that an operating bandwidth for a first cell is greater than a first predefined threshold comprises determining that a cell site load is less than the first predefined threshold for a predefined interval; and
performing the at least one configuration change to reduce power consumption by the network node comprises:
scaling the operating bandwidth for the cell site to a next lower level;
determining whether the operating bandwidth after scaling is greater than a lowest possible bandwidth supported by the network node;
if the operating bandwidth after scaling is greater than the lowest possible bandwidth supported by the network node, scaling the operating bandwidth a next lower level if the next lower level supports the cell site load.

19. A non-transitory computer-readable storage medium, having stored there on a computer program that, when executed on one or more processors, causes the one or more processors to:
determine that an operating bandwidth for a first cell is greater than a first predefined threshold;
determine that a number of user devices being actively serviced by the network node is equal to or less than a second predefined threshold; and
perform at least one configuration change to reduce power consumption by the network node.

20. The storage medium of claim 19, wherein, when performing the at least one configuration change, the one or more processors are further configured to deactivate at least one power amplifier in the network node.

21. The storage medium of claim 19, wherein:
the second predefined threshold is zero; and
when performing the at least one configuration change, the one or more processors are configured to perform a step selected from the group consisting of:
reducing the operating bandwidth for the first cell to a lowest possible bandwidth supported by the network node;
switching the network node from a multi input multi output configuration to a single input multi output or single input single output configuration;
determining that no active user devices are operating in spatial multiplexing mode and switching the network node from a multi input multi output configuration to a single input multi output or single input single output configuration.

22. The storage medium of claim 19, wherein when performing the at least one configuration change the one or more processors are further configured to reduce the operating bandwidth for the first cell to a lowest possible bandwidth supported by the network node, the lowest possible bandwidth supported by the network node is selected from the group comprising 5 MHz, 3 MHz, and 1.4 MHz.

23. The storage medium of claim 19, wherein:
the second predefined threshold is associated with a low load setting; and
when performing the at least one configuration change, the one or more processors are further configured to reduce the operating bandwidth for the first cell to a lowest possible bandwidth that will support the number of user devices being actively supported by the network node.

24. The storage medium of claim 19, wherein the one or more processors are further configured to:
determine that the network node is operating at the lowest operating bandwidth supported by the network node; and
dynamically switch the network node from a MIMO configuration to a SISO configuration.

25. A network node for providing service to a plurality of cells, comprising:
a transceiver comprising a plurality of amplifiers;
one or more processors; and
a non-transitory computer-readable storage medium further including computer-readable instructions that, when executed by the one or more processors, are configured to:
determine that an operating bandwidth for a first cell is greater than a first predefined threshold;
determine that a physical resource block utilization is greater than a second predefined threshold;
determine whether the network node is operating in a multi input multi output configuration;
if the network node is not operating in a multi input multi output configuration, scale the operating bandwidth down to a lowest possible operating bandwidth that can accommodate a current level of traffic;
if the network node is operating in a multi input multi output configuration,
scale the operating bandwidth to a lowest possible operating bandwidth that is supported by the network node;
dynamically switch the network node from a MIMO configuration to a SISO configuration;
determine that all cells within the plurality of cells are operating at the lowest possible operating bandwidth supported by the network node; and
deactivate at least one of the plurality of power amplifiers.
